(19) United States
(12) Patent Application Publication
(10) Pub. No.: US 2024/0032676 A1
(43) Pub. Date: Feb. 1, 2024

(54) HUNTING GEAR BACKPACK APPARATUS AND METHOD OF USE THEREOF

(71) Applicant: Steven Edward Finster, Evans Mills, NY (US)

(72) Inventor: Steven Edward Finster, Evans Mills, NY (US)

(21) Appl. No.: 18/228,522

(22) Filed: Jul. 31, 2023

Related U.S. Application Data
(60) Provisional application No. 63/393,540, filed on Jul. 29, 2022.
(60) Provisional application No. 63/397,924, filed on Aug. 15, 2022.

(51) Int. Cl. A45F 3/08; A45F 3/04

(52) U.S. Cl. CPC A45F 3/08; A45F 3/047; A01M 31/02

(57) ABSTRACT

A backpack frame includes external frame components and a durable plastic sheet having a first portion and a second portion that is perpendicular to the first portion. The first portion protects the wearer's back from sharp and hard objects attached to the backpack, such as climbing sticks or tree stand components. The second portion supports the weight of the climbing sticks or tree stand components.

### CROSS-REFERENCE TO RELATED APPLICATIONS

This application claims the benefit of U.S. Provisional Patent Application No. 63/397,924, filed Aug. 15, 2022, and U.S. Provisional Patent Application No. 63/393,540, filed Jul. 29, 2022, both of which are hereby incorporated by reference in their entireties.

### TECHNICAL FIELD

This disclosure relates to backpacks.

### BACKGROUND OF THE INVENTION

Hunters often hunt from an elevated position above the ground, which reduces the likelihood that they will be detected by game animals while also providing the hunter with an enhanced field of view for spotting and shooting game animals. To obtain an elevated position, hunters typically climb a tree.

The prior art includes various devices to assist a hunter in climbing a tree and supporting the hunter once the hunter is in his or her desired position. For example, climbing sticks are rods with steps attached thereto; the rods are mountable to the tree such that the steps are vertically spaced apart from each other; a hunter may then climb the tree using the steps. A tree stand is mountable to a tree at an elevated position to provide a seat and/or a foot rest to comfortably support the hunter while waiting for game.

Climbing sticks and portable tree stands are more portable than traditional tree stands with ladders, but still present transportation challenges when a hunter wants to take them to a remote hunting location and must carry them without the assistance of a vehicle.

### SUMMARY

A backpack apparatus for conveniently carrying hunting gear, and especially tree climbing equipment, is provided herein. The backpack apparatus includes an external backpack frame having first, second, third, and fourth segments. The first and second segments are parallel to one another. The third and fourth segments extend substantially parallel to one another and perpendicularly to the first and second segments. Thus, when the first and second segments are generally vertical, the third and fourth segments are generally horizontal. The first and second segments define a first space therebetween, and the third and fourth segments define a second space therebetween.

The backpack apparatus also includes a harness mounted to the frame. The harness includes at least two shoulder straps configured to engage a user's shoulders such that the first and second segments are generally parallel with a user's back. The backpack apparatus further includes a durable polymeric sheet that is mounted to the first, second, third, and fourth segments of the frame such that the durable polymeric sheet transfers loads to each of the segments.

The durable, polymeric sheet is characterized by a first generally planar portion, a second generally planar portion, and a bend that interconnects the first and second generally planar portions. The first generally planar portion extends across or over the first space, and the second generally planar portion extends across or over the second space.

The backpack apparatus provided herein improves upon the prior art because it facilitates the carrying of climbing equipment and other hard and possibly sharp objects without causing damage to the backpack apparatus or the user of the backpack apparatus. More specifically, prior art backpacks are not suitable for carrying climbing equipment because the nature of the climbing equipment is likely to damage the material of the backpack. Furthermore, the soft material of prior art backpacks would transfer the forces and pressures from the climbing equipment to the user's back, thereby causing discomfort or injury to the user. The durable polymeric sheet of the apparatus provided herein protects both the backpack and the wearer from damage that would likely be caused by the climbing equipment. Furthermore, the use of a durable plastic sheet enables a user to easily wash scents and odors that could alert game animals from the major surfaces of the backpack.

In one embodiment of the backpack apparatus, the frame and sheet are dimensioned such that a plurality of climbing sticks are attachable with respect to the frame such that the plurality of climbing sticks are coplanar with one another in a plane that is parallel to the first portion of the sheet. This arrangement of climbing sticks relative to the backpack apparatus provides for improved comfort to the wearer because the center of gravity of the climbing sticks is closer to the wearer's back. This arrangement is also beneficial because it limits rearward protrusion of the backpack from the wearer when loaded, which minimizes the backpack being caught or entangled in brush, etc.

The durable plastic sheet provides a surface that is ideal for use as a cutting board. A corresponding method of using the backpack apparatus is provided in which the durable plastic sheet supports pieces of meat while being cut with a knife.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, perspective view of a frame assembly of a backpack apparatus, the frame assembly including a durable sheet;

FIG. 2 is a schematic, rear view of a harness assembly mountable to the frame assembly;

FIG. 3 is a schematic, perspective view of the backpack apparatus with climbing sticks between the sheet and a pack and covered by a slip cover;

FIG. 4 is a schematic, side view of the backpack apparatus of FIG. 3;

FIG. 5 is a schematic, top view of the backpack apparatus of FIGS. 3 and 4 with the slip cover removed; and

FIG. 6 is a schematic, perspective view of the frame assembly being used as a cutting board.

### DETAILED DESCRIPTION

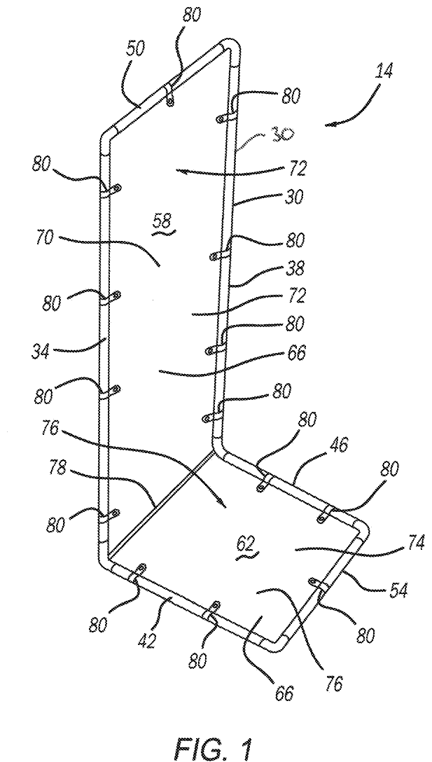

Referring to the Figures, wherein like reference numbers refer to like components throughout, a hunting gear backpack apparatus 10 is schematically depicted. The hunting gear backpack apparatus 10 in the embodiment depicted includes a frame assembly 14, a harness assembly 18, a soft pack assembly 22, and a slip cover 26. As best shown in FIG. 1, the frame assembly 14 includes a frame 30 having a first segment 34, a second segment 38, a third segment 42, a fourth segment 46, a fifth segment 50, and a sixth segment 54. Each of the segments 34-54 is substantially linear and, in the embodiment depicted, cylindrical. The frame segments 34-54 may be formed of any suitable material within the scope of the claimed invention, including but not limited to PVC and aluminum tubes.

The first segment 34 and the second segment 38 are spaced apart from, and parallel to, one another. The third segment 42 is connected to, and extends perpendicularly from, the lower end of the first segment 34. The fourth segment 46 is connected to, and extends perpendicularly from, the lower end of the second segment 38 such that the fourth segment 46 is parallel to the third segment 42. The third and fourth segments 42, 46 extend rearward from the first and second segments 34, 38. The fifth segment 50 is perpendicular to, and interconnects, the upper ends of the first and second segments 34, 38. The sixth segment 54 interconnects the rearward ends of segments 46, 50, and thus the sixth segment 54 is perpendicular to the fourth and fifth segments 46, 50.

As used herein, directional terms such as “upper” and “lower” refer to the orientation of the apparatus 10 when it is in a use position being worn by a user, or when the third, fourth, and sixth segments 42, 46, 54 are horizontally oriented and in contact with the ground or other supporting surface. Other directional terms such as “forward” and “rearward” are from the perspective of a wearer when the apparatus 10 is in the use position.

The first, second, and fifth segments 34, 38, 50 define a first space 58 therebetween. The third, fourth, and sixth segments 42, 46, 54 define a second space 62 therebetween. The frame 30 includes a durable polymeric sheet 66 that is mounted to the first, second, third, fourth, fifth, and sixth segments 34, 38, 42, 46, 50, 54 of the frame 30 such that the durable polymeric sheet 66 transfers loads to each of the segments 34-54. More specifically, the sheet 66 transfers loads having a vertical component to at least segments 42, 46, 54. The sheet 66 transfers loads having a horizontal component to at least segments 34, 38, 50.

The durable, polymeric sheet 66 is characterized by a first generally planar portion 70 defining a first surface 72, a second generally planar portion 74 defining a second surface 76, and a bend 78 that interconnects the first and second generally planar portions 70, 74 such that the first generally planar portion 70 and the second generally planar portion 74 are substantially perpendicular to one another. The first and second surfaces 72, 76 are substantially flat and are substantially perpendicular to one another. The sheet 66 is mounted to the frame 30 such that the first generally planar portion 70 extends across or over the first open space 58, and the second generally planar portion 74 extends across or over the second open space 62. The sheet 66 is mounted to each of the segments 34, 38, 42, 46, 50, 54 by one or more stainless steel pipe clamps 80 in the embodiment depicted, though other fasteners or fastening methods may be employed within the scope of the claimed invention.

The sheet 66 is preferably high-density polyethylene (HDPE), though other materials may be employed within the scope of the claimed invention. The sheet 66 is preferably at least 1/16 inches thick, and more preferably at least ⅛ inches thick. In one embodiment, the sheet 66 is thermoformed to form the bend 78.

The material forming the sheet 66 preferably has one or more of the following minimum mechanical properties: a tensile strength, yield at 23 C of at least 15 MPa, and more preferably between 23.0 and 29.5 MPa; a tensile strength, break at 23 C of at least 20 MPa; and more preferably between 30.5 and 33 MPa; an elongation, yield of at least 5%, and more preferably between 9% and 18%; an elongation, break of at least 400%, and more preferably between 600% and 1350%; a tensile modulus at 23 C of at least 600 MPa, and more preferably between 900 and 1550 MPa; and a flexural modulus of at least 700 MPa and more preferably between 970 and 1380 MPa.

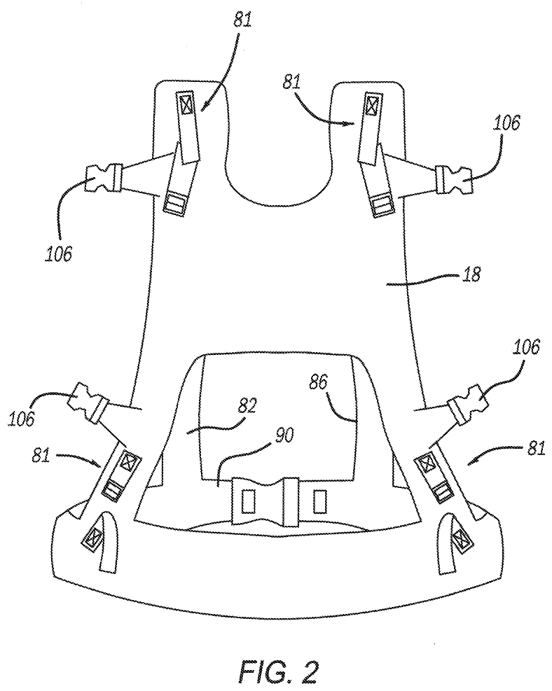

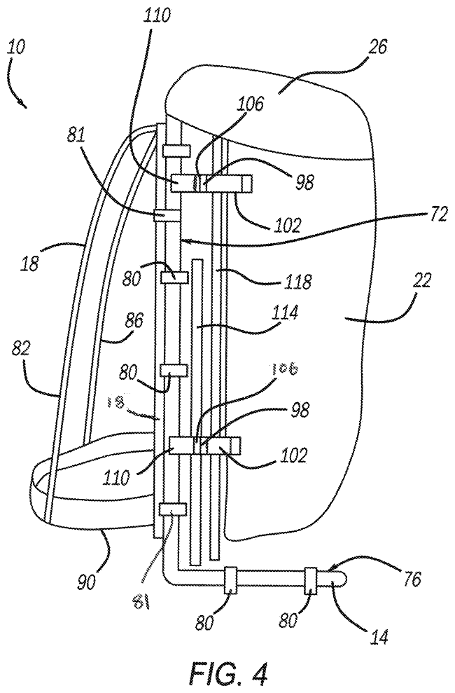

Referring to FIG. 2, the harness assembly 18 includes fastening elements 81 that are configured to engage with the frame 30 to mount the harness assembly 18 to the frame 30. The fastening elements 81 are straps with at least one buckle to form loops around segments 34, 38 (as shown in FIG. 4) to connect the harness assembly 18 to the frame 30, though other fastening elements may be employed within the scope of the claimed invention. The harness assembly 18 includes two shoulder straps 82, 86 and, in the embodiment depicted, a waist band 90 to engage a user or wearer of the backpack apparatus 10 in a manner understood by those skilled in the art.

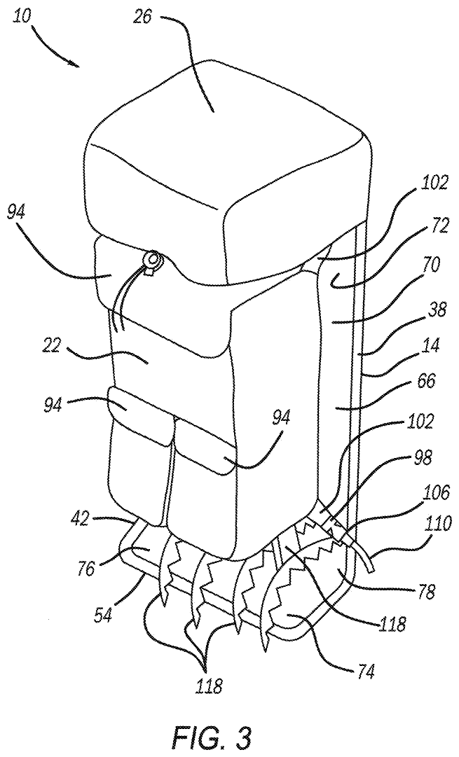

Referring to FIGS. 3-5, the pack 22 is a fabric container that defines one or more storage compartments, as understood by those skilled in the art. The pack 22 in the embodiment depicted includes closures 94 that are movable in a known manner to selectively open and close the compartments. The pack 22 also includes a plurality of fastening elements such as buckle components 98 that are mounted to the fabric material via straps 102. Buckle components 98 are releasably engageable with complementary buckle components 106, which are connected to frame segments 34, 38 via straps 110.

The backpack apparatus 10 is uniquely suited for transporting a tree stand (i.e., platform 114) and a plurality of climbing sticks 118. Climbing sticks, also sometimes known by those skilled in the art as “ladder modules” are known and understood by those skilled in the art. Each climbing stick 118 includes a rod or “spine,” steps mounted to the rod or “spine,” tree brackets mounted to the rod or “spine” for engagement with a tree, and systems for mounting the rod or “spine” to a tree, including various straps, etc.

Climbing sticks 118 may be similar or identical to the “ladder modules” shown and described in U.S. Pat. No. 8,556,035, issued Oct. 15, 2013 to Kendall et al., and which is hereby incorporated by reference in its entirety. Tree stand 114 may be similar or identical to the tree stand shown and described in U.S. Pat. No. 8,556,035.

To use the backpack apparatus 10 for transporting the platform 114 and the climbing sticks 118, a user places the platform 114 against the surfaces 72, 76 of planar portions 70, 74 of the sheet 66. The second planar portion 74 is horizontal and lower than the first planar portion 70 in the use position, and surface 76 faces upward; thus the second planar portion 74 supports the weight of the platform 114. The platform 114 is substantially vertically oriented.

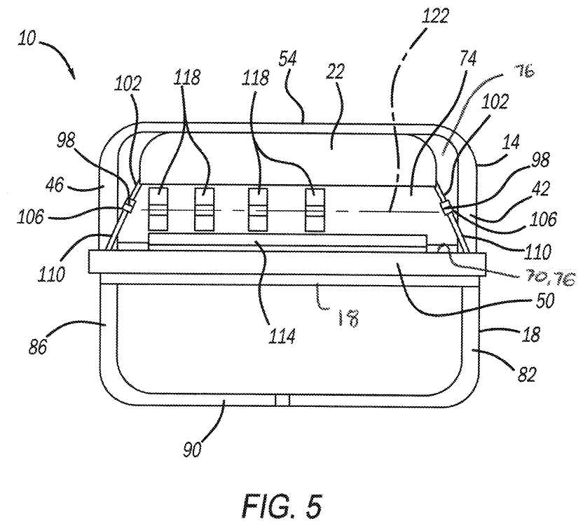

The climbing sticks 118 are then arranged along a plane 122 that is parallel to the first planar portion 70 and the first surface 72. More specifically, the rod or “spine” of each climbing stick is vertical and is within a plane 122 that is parallel to the surface of the first planar portion 70 of the sheet 66, as shown in FIGS. 4 and 5. The plane 122 extends laterally with respect to the backpack apparatus 10; accordingly, the climbing sticks 118 are spaced apart from each other laterally relative to the backpack apparatus 10. The second planar portion 74 may likewise bear most of the weight of the climbing sticks 118. It should be noted that four climbing sticks 118 are within the plane 122 in the embodiment shown.

Buckle components 98 may then be engaged with complementary buckle components 106 to attach the pack 22 to the frame 30 such that the pack 22 is rearward of the climbing sticks 118 as shown in FIGS. 3-5. The arrangement of the climbing sticks 118 along the transverse plane 122 enable the pack 22 to be placed further forward for packaging efficiency. Straps 102 and/or straps 110 may be cinchable or otherwise adjustable.

It should be noted that the harness assembly 18 also includes a plurality of complementary buckle components 106 that are engageable with the buckle components 98 of pack 22. Accordingly, the pack 22 may be directly connected to the harness assembly 18 without the frame assembly 14 if desired.

Once the climbing sticks 118, platform 114, and pack 22 are arranged as shown in FIGS. 4 and 5, the slip cover 26 is then placed over the top of the frame 30, the platform 114, the sticks 118, and at least a portion of the pack 22 as shown in FIGS. 3 and 4 (the cover 26 is not shown in FIG. 5 for a clear view of the arrangement of the climbing sticks 118). The climbing sticks 118 and platform 114 are securely placed between the pack 22 and the sheet 66, and the cover 26 prevents the sticks 118 from catching on any branches or brush while the backpack apparatus 10 is being worn. The sheet 66 separates the wearer's back from the platform 114 and sticks 118, and its durability and toughness prevent sharp portions of the platform 114 or sticks 118 from poking the wearer. Furthermore, the sheet 66 can withstand abrasions and forces of the sticks 118 that would damage prior art backpacks.

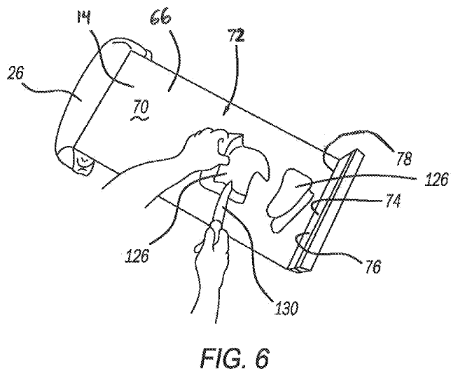

FIG. 6, wherein like reference numbers refer to like components from FIGS. 1-5, schematically depicts another method of using the backpack apparatus 10, and, more specifically, using the durable plastic sheet 66. Referring to FIG. 6, the method may include disconnecting the pack 22 from the frame assembly 14 and harness assembly 18, and then removing the sticks 118 and tree stand 114 from the frame assembly 14 such that the surface 72 of the first generally planar portion 70 is exposed. The method also includes positioning the frame assembly 14 such that first generally planar portion 70 is generally horizontal and the surface 72 faces upward, as shown in FIG. 6.

The material properties of the sheet 66, and therefor the planar portion 70 and surface 72, make the sheet 66 resistant to scratching and cutting, water-resistant, and easy to clean. The sheet 66, including planar portion 70, is characterized by the absence of holes, except for holes around the periphery of the sheet 66 through which threaded fasteners extend to connect clamps (shown at 80 in FIG. 1) to the sheet 66. Thus, the sheet 66 does not include any unfilled or uncovered holes. These qualities of the sheet 66 make it ideal for use as a cutting board.

When the backpack apparatus 10 is used by a hunter or angler, and the hunter or angler is successful in harvesting a game animal, then the backpack apparatus 10 may be used in the processing of the game animal. More specifically, the method further includes placing pieces of meat 126 (which may include fowl or fish) on the surface 72 to be supported thereby, and cutting the pieces of meat 126, with the pieces of meat 126 supported on the surface 72, with a knife 130.

The frame assembly 14 may be supported on any surface while in use as a cutting board. For example, the frame assembly 14 may be supported by the open tailgate of a pickup truck, on the ground, on a rock, etc.

Accordingly, the backpack apparatus 10 further improves upon the prior art by providing a clean, reusable surface for processing game.

While the best modes for carrying out the disclosure have been described in detail, those familiar with the art to which this disclosure relates will recognize various alternative designs and embodiments for practicing the disclosure within the scope of the appended claims.

1. A hunting gear backpack apparatus comprising:
an external backpack frame having first, second, third, and fourth segments;
said first and second segments being parallel to, and spaced a distance apart from, one another;
said third and fourth segments being parallel to, and spaced a distance apart from one another;
said third and fourth segments being perpendicular to the first and second segments; and
a durable plastic sheet having a bend formed therein such that the sheet has a first substantially planar portion and a second substantially planar portion that is perpendicular to the first substantially planar portion;
said first substantially planar portion being mounted to the first and second segments; and
said second substantially planar portion being mounted to the third and fourth segments.

2. The hunting gear backpack apparatus of claim 1, wherein the durable plastic sheet has
a tensile strength, yield at 23 C of at least 20 MPa;
a tensile strength, break at 23 C of at least 25 MPa;
an elongation at yield of at least 7%;
an elongation at break of at least 550%;
a tensile modulus at 23 C of at least 800 MPa; and
a flexural modulus of at least 850 MPa.

3. The hunting gear backpack apparatus of claim 2, wherein the durable plastic sheet has
a tensile strength, yield at 23 C between 23.0 and 29.5 MPa
a tensile strength, break at 23 C between 30.5 and 33 MPa;
an elongation at yield between 9% and 18%;
an elongation at break between 600% and 1350%;
a tensile modulus at 23 C between 900 and 1550 MPa; and
a flexural modulus between 970 and 1380 MPa.

4. The hunting gear backpack apparatus of claim 3, wherein the durable plastic sheet is high density polyethylene.

5. The hunting gear backpack apparatus of claim 1, further comprising a harness assembly including at least two shoulder straps mounted to the frame.

6. The hunting gear backpack apparatus of claim 5, further comprising a pack assembly having a fabric container and a first set of fastening elements mounted with respect to the fabric container;
a second set of fastening elements mounted with respect to the external backpack frame;
wherein the first set of fastening elements is releasably engageable with the second set of fastening elements to releasably connect the fabric container to the external backpack frame.

7. The hunting gear backpack apparatus of claim 6, further comprising a tree stand platform and a plurality of climbing sticks;
said platform abutting the first planar portion of the durable plastic sheet such that the platform is parallel to the first planar portion;
said plurality of climbing sticks being arranged such that the climbing sticks are coplanar about a plane that is parallel to the first planar portion of the durable plastic sheet and the tree stand platform; and
said tree stand platform and said plurality of climbing sticks being between the sheet and the pack assembly.

8. The hunting gear backpack apparatus of claim 6, further comprising a third set of fastening elements mounted with respect to the harness assembly;
wherein the third set of fastening elements is releasably engageable with the first set of fastening elements such that the harness assembly is releasably connectable to the pack assembly independently of the external backpack frame.

9. A method comprising:
possessing hunting gear backpack apparatus of claim 5;
exposing the first planar portion of the durable plastic sheet;
orienting the durable plastic sheet such that the first planar portion is generally horizontal and has a surface that faces upward;
placing a piece of meat on the upwardly-facing surface of the durable plastic sheet; and
cutting the piece of meat on the upwardly-facing surface with a knife.

10. A method comprising:
possessing an external backpack frame having a durable plastic sheet; said plastic sheet including a first portion and a second portion that is substantially perpendicular to the first portion;
placing equipment against the first and second portions; and
attaching a pack including a fabric container to the frame so that the equipment is between the pack and the frame.

11. The method of claim 10, wherein the equipment includes a plurality of climbing sticks, each of said climbing sticks having a respective rod, steps mounted to the rod, and a tree-engaging member mounted to the rod.

12. The method of claim 11, wherein said placing equipment against the first and second portions includes placing each of the climbing sticks within a plane that is parallel to the first portion of the sheet.

13. The method of claim 12, wherein the equipment further includes a tree stand platform.

14. The method of claim 13, further comprising attaching a harness assembly having shoulder straps to the frame so that the shoulder straps are on the opposite side of the frame from the pack.

15. The method of claim 14, further comprising placing a cover over the frame, the equipment, and the pack.
